(19) United States
(12) Patent Application Publication
(10) Pub. No.: US 2014/0025527 A1
(43) Pub. Date: Jan. 23, 2014

(54) Automated Negotiation

(71) Applicants: Haeyoung Noh, Palo Alto, CA (US); Mehmet Kivanc Ozonat, San Jose, CA (US); Sharad Singhal, Belmont, CA (US)

(72) Inventors: Haeyoung Noh, Palo Alto, CA (US); Mehmet Kivanc Ozonat, San Jose, CA (US); Sharad Singhal, Belmont, CA (US)

(21) Appl. No.: 14/003,264

(22) PCT Filed: Apr. 6, 2011
(86) PCT No.: PCT/US11/31374

§ 371 Date: Sep. 5, 2013

(51) Int. Cl. G06Q 30/06

(52) U.S. Cl. CPC G06Q 30/0611
USPC 705/26.4

(57) ABSTRACT

A potential transaction between a first party and a second party involves multiple issues. A current offer made by the second party is received. A set of candidate counteroffers that satisfy a target utility value for the first party is identified. A counteroffer is selected from among the set of candidate counteroffers and presented to the second party.

### BACKGROUND

Electronic commerce technologies enable consumers to purchase products and services from businesses online.

### BRIEF DESCRIPTION OF THE DRAWINGS

FIGS. 1A and 1B are schematic diagrams of an example user interface for interacting with an automated negotiation agent.

FIG. 2 is a block diagram of an example of a communications system.

FIG. 3 is a schematic diagram of a system for estimating the relative importance of issues to a party in a negotiation.

FIG. 4 is a flowchart illustrating an example of a process for conducting an automated negotiation.

### DETAILED DESCRIPTION

An automated negotiation agent conducts negotiations with human counterparts. During such an automated negotiation, the automated negotiation agent estimates measures of the relative importance of the issues involved in the negotiation to its human counterpart. For example, assuming that the human counterpart concedes relatively more quickly for relatively less important issues during negotiation, the automated negotiation agent may monitor the rates at which the human counterpart concedes issues and use such concession rates to generate estimated measures of the relative importance of the issues to its human counterpart. The automated negotiation agent then may use these estimated measures of the relative importance of the issues to the human counterpart to generate counteroffers perceived as being acceptable to both the human counterpart and the party on behalf of whom the automated negotiation agent is acting.

In some implementations, the automated negotiation agent may propose two counteroffers to its human counterpart during a round of negotiation. For example, the automated negotiation agent may propose one counteroffer that is intended to address the human counterpart's utility across multiple issues involved in the negotiation and another counteroffer that is intended to address the human counterpart's utility for the issue perceived as being most important to the human counterpart.

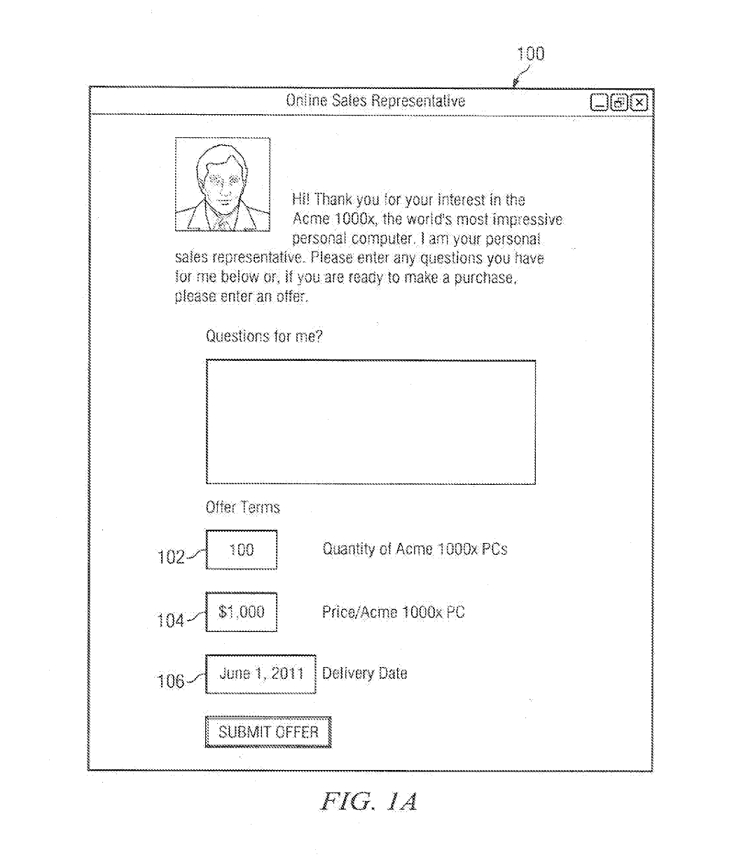

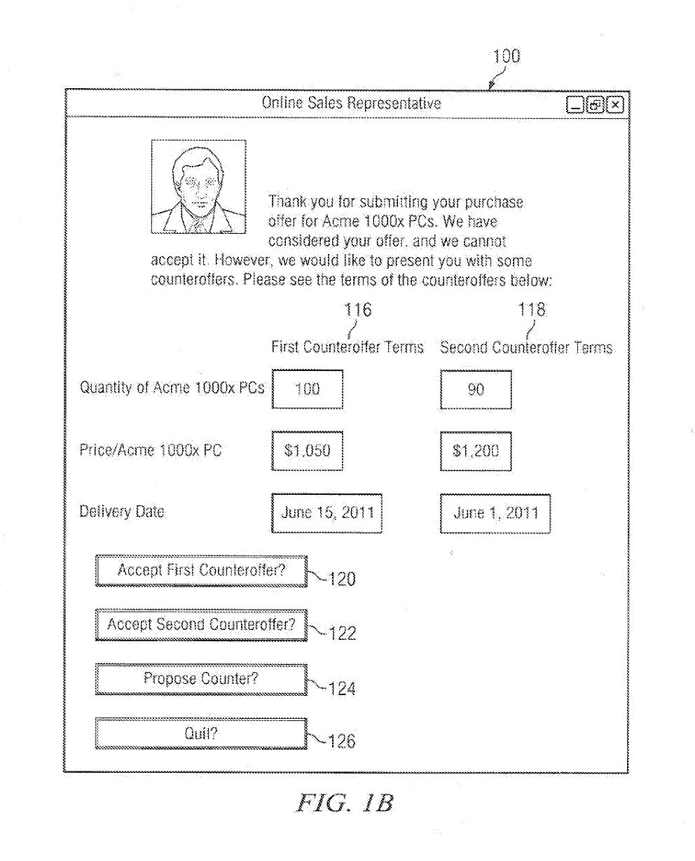

FIGS. 1A and 1B are schematic diagrams of an example user interface 100 for interacting with an automated negotiation agent. The automated negotiation agent, which may be implemented as one or more applications executing on one or more servers or other computing devices, is configured to engage, on behalf of a business, in a negotiation over different terms of a transaction with a human counterpart. For example, the automated negotiation agent may be configured to receive and evaluate offers submitted by a human counterpart, enabling the automated negotiation agent and the human counterpart to engage in a back and forth exchange of offer and counteroffer until the automated agent and the human counterpart are able to agree upon terms of the transaction or until one party decides to terminate the negotiation.

In the example illustrated in FIGS. 1A and 1B, the automated negotiation agent is configured to negotiate the terms of the sale of one or more personal computers with a human counterpart, and the user interface 100 enables a user to submit terms of an offer to the automated agent. In particular, the user interface 100 includes a quantity field 102, a unit price field 104, and a delivery date field 106 that enable the human counterpart to propose a quantity of personal computers to be purchased, a unit price for each personal computer, and a delivery date, respectively, as the terms of an offer. As illustrated in FIG. 1A, the human counterpart has proposed to purchase 100 personal computers at a purchase price of $1,000 per personal computer, with a delivery date for the personal computers of Jun. 1, 2011.

In response to receiving the terms proposed by the human counterpart, the automated agent considers the terms proposed by the human counterpart and determines if the terms are acceptable to the business on behalf of whom the automated negotiation agent is negotiating. In the event that the automated negotiation agent determines that the terms proposed by the human counterpart are not acceptable to the business that the automated negotiation agent is representing, the automated negotiation agent may determine to make one or more counteroffers to the human counterpart with terms that are acceptable to the business that the automated negotiation agent is representing.

As illustrated in FIG. 1B, in response to deciding that the human counterpart's initial proposal to purchase 100 personal computers at a purchase price of $1,000 per personal computer with a delivery date of Jun. 1, 2011 is not acceptable, the automated negotiation agent proposed two separate counteroffers 116 and 118, each with terms acceptable to the business on behalf of whom the automated negotiation agent is negotiating. In particular, the automated negotiation agent presented a first counteroffer 116 with an increased unit purchase price of $1,050 per personal computer and a delayed delivery date of Jun. 15, 2011 for the same quantity of 100 personal computers as proposed by the human counterpart and a second counteroffer 118 with an increased unit purchase price of $1,200 per personal computer and a reduced quantity of 90 personal computers with the same delivery date of Jun. 1, 2011 as proposed by the human counterpart.

In calculating the terms for the first counteroffer 116, the automated negotiation agent may have attempted to identify terms that are both acceptable to the business that the automated negotiation agent is representing and that balance the human counterpart's utility across the three issues of quantity, price, and delivery date. In contrast, in calculating the terms for the second counteroffer 118, the automated negotiation agent may have attempted to identify terms that are acceptable to the business that the automated negotiation agent is representing and that provide the best possible term to the human counterpart for the issue perceived by the automated negotiation agent as being most important to the human counterpart. For example, based on the history of the negotiation with the human counterpart, the automated negotiation agent may have inferred that delivery date is the most important issue to the human counterpart. Therefore, as illustrated in FIG. 1B, the second counteroffer 118 proposed by the automated negotiation agent has a delivery date of Jun. 1, 2011, which matches the delivery date requested by the human counterpart, but also has quantity and price terms that are slightly different from the terms requested by the human counterpart.

As further illustrated in FIG. 1B, in addition to presenting the terms of the automated negotiation agent's counteroffers 116 and 118 to the human counterpart, the interface 100 also provides a selectable control 120 that enables the human counterpart to accept the automated negotiation agent's first counteroffer 116 and consummate the transaction according to the terms of the first counteroffer 116, a selectable control 122 that enables the human counterpart to accept the automated negotiation agent's second counteroffer 118 and consummate the transaction according to the terms of the second counteroffer 118, a selectable control 124 that enables the human counterpart to propose a counteroffer to the automated negotiation agent's offers 116 and 118, and a selectable control 126 that enables the human counterpart to terminate the negotiation.

Should the human counterpart decide to propose a counteroffer to the automated negotiation agent's offers 116 and 118 by selecting selectable control 124, the human counterpart and the automated negotiation agent can continue the negotiation, going back and further exchanging offers and counteroffers, until the human counterpart and the automated negotiation agent arrive at mutually agreeable terms or until one party decides to terminate the negotiation.

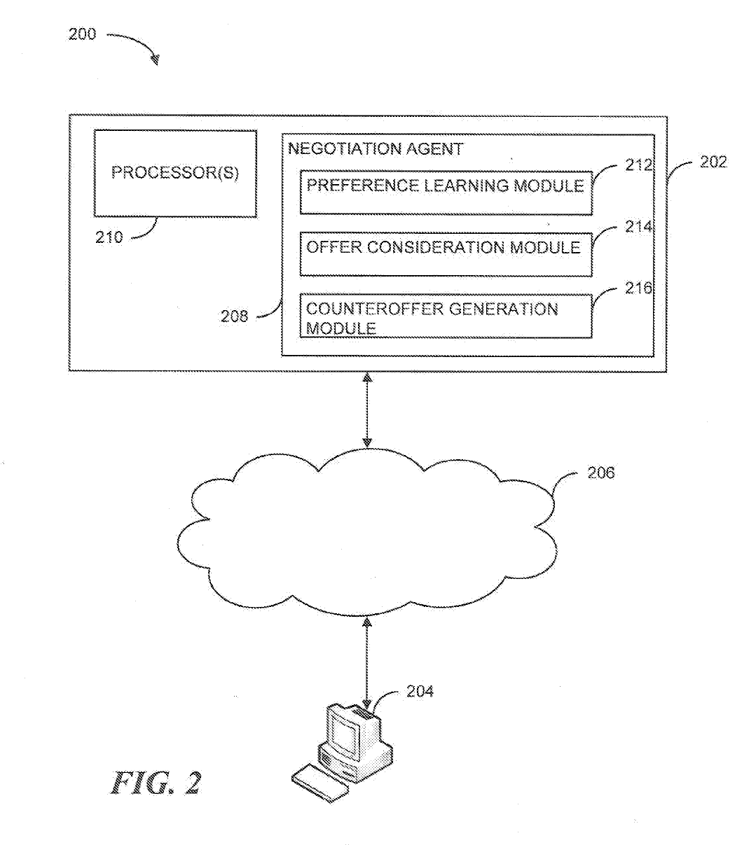

FIG. 2 is a block diagram of an example of a communications system 200 that includes an electronic commerce complex 202, a computer 204, and a network 206 and that enables a human user of computer 204 to engage in automated negotiations with an automated negotiation agent 208 executing on electronic commerce complex 202. For illustrative purposes, several elements illustrated in FIG. 2 and described below are represented as monolithic entities. However, these elements each may include and/or be implemented on numerous interconnected computing devices and other components that are designed to perform a set of specified operations and that are located proximally to one another or that are geographically displaced from one another.

As illustrated in FIG. 2, the electronic commerce complex 202 and automated negotiation agent 208 are accessible to computer 204 over network 206.

Computer 204 may be any of a number of different types of computing devices including, for example, a personal computer, a special purpose computer, a general purpose computer, a combination of a special purpose and a general purpose computing device, a laptop computer, a tablet computer, a netbook computer, a smart phone, a mobile phone, a personal digital assistant, and a portable media player. Computer 204 typically has internal or external storage components for storing data and programs such as an operating system and one or more application programs. Examples of application programs include authoring applications (e.g., word processing programs, database programs, spreadsheet programs, or graphics programs) capable of generating documents or other electronic content; client applications (e.g., e-mail clients) capable of communicating with other computer users, accessing various computer resources, and viewing, creating, or otherwise manipulating electronic content; and browser applications capable of rendering standard Internet content. In addition, the internal or external storage components for computer 204 may store a dedicated client application for interfacing with electronic commerce complex 202 and/or automated negotiation agent 208. Alternatively, in some implementations, computer 204 may interface with electronic commerce complex 202 and automated negotiation agent 208 without a specific client application (e.g., using a web browser).

Computer 204 also typically includes a central processing unit (CPU) for executing instructions stored in storage and/or received from one or more other electronic devices, for example over network 206. In addition, computer 204 also usually includes one or more communication devices for sending and receiving data. One example of such a communications device is a modem. Other examples include an antenna, a transceiver, a communications card, and other types of network adapters capable of transmitting and receiving data over network 206 through a wired or wireless data pathway.

Electronic commerce complex 202 may be implemented using one or more computing devices (e.g., servers) configured to provide a service to one or more client devices (e.g., computer 204) connected to electronic commerce complex 202 over network 206. The one or more computing devices on which electronic commerce complex 202 is implemented may have internal or external storage components storing data and programs such as an operating system and one or more application programs. The one or more application programs may be implemented as instructions that are stored in the storage components and that, when executed, cause the one or more computing devices to provide the features of the electronic commerce complex 202 and/or automated negotiation agent 208 described herein.

Furthermore, the one or more computing devices on which electronic commerce complex 202 is implemented each may include one or more processors 210 for executing instructions stored in storage and/or received from one or more other electronic devices, for example over network 206. In addition, these computing devices also typically include network interfaces and communication devices for sending and receiving data.

Network 206 may provide direct or indirect communication links between electronic commerce complex 202 and computer 204 irrespective of physical separation between any of such devices. As such, electronic commerce complex 202 and computer 204 may be located in close geographic proximity to one another or, alternatively, electronic commerce complex 202 and computer 204 may be separated by vast geographic distances. Examples of network 206 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data. In some implementations, computer 204 may be connected to network 206 over a wireless connection (e.g., a WLAN based on the IEEE 802.11 standard, a radio frequency-based wireless network, and/or a cellular or mobile telephony network provided by a wireless service provider) made available by a private service provider.

Electronic commerce complex 202 may provide access to a catalog or other collection of products or services that are available for sale from a business, and a human user of computer 204 may be able to access and browse such a catalog or other collection of products or services for sale over network 206. In the event that, through the course of browsing the catalog or other collection of products or services that are available for sale, a human user of computer 204 locates a product or service that the human user is interested in purchasing, the human user may use computer 204 to communicate that interest to electronic commerce complex 202. In response, automated negotiation agent 208 then may engage the human user of computer 204 in an automated negotiation over the terms of the transaction, during the course of which the automated negotiation agent 208 and the human user of computer 204 present offers and counteroffers to one another by exchanging electronic messages over network 206.

As illustrated in FIG. 2, automated negotiation agent 208 includes a preference learning module 212, an offer consideration module 214, and a counteroffer generation module 216. Preference learning module 212 is configured to monitor a party's behavior over the course of a negotiation with automated negotiation agent 208 and to estimate the party's preferences with respect to the issues involved in the negotiation based on the party's behavior over the course of the negotiation. In some implementations, preference learning module 212 may store a history of the terms proposed by the party in each round of the negotiation with the automated negotiation agent 212. Preference learning module 212 then may estimate the party's preferences with respect to the issues involved in the negotiation based on the terms proposed by the party throughout the negotiation. Preference learning module 212 may be implemented as instructions stored in a computer memory storage system that, when executed, cause processor(s) 210 to provide the preference-learning functionality ascribed herein to the preference learning module 212.

Electronic commerce complex 202 also includes an offer consideration module 214. During the course of a negotiation with a party, offer consideration module 214 is configured to analyze offers made by the party and received by automated negotiation agent 208 and decide whether such offers should be accepted or denied by automated negotiation agent 208. For example, offer consideration module 214 may have access to a utility function for the party represented by the automated negotiation agent 208. Offer consideration module 214 may decide to accept an offer that, when applied to the utility function, results in a utility value for the offer that is greater than or equal to some predetermined minimum target utility value of the party represented by the automated negotiation agent 208. Likewise, offer consideration module 214 may decide to reject an offer that, when applied to the utility function, results in a utility value for the offer that is less than the target utility value of the party represented by the automated negotiation agent 208. Offer consideration module 214 may be implemented as instructions stored in a computer memory storage system that, when executed, cause processor(s) 210 to provide the offer consideration functionality ascribed herein to the offer consideration module 214.

Electronic commerce complex 202 also includes a counteroffer generation module 216. Counteroffer generation module 216 may be implemented as instructions stored in a computer memory storage system that, when executed, cause processor(s) 210 to provide the counteroffer generation functionality ascribed herein to the counteroffer generation module 216.

When offer consideration module 214 decides to reject an offer received by the automated negotiation agent 208 from a party during a negotiation with automated negotiation agent 208, automated negotiation agent 208 may use counteroffer generation module 216 to generate terms of one or more counteroffers to propose to the party from which the rejected offer was received. Counteroffer generation module 216 may construct such counteroffers based on information about the party's estimated preferences with respect to the issues involved in the negotiation provided by preference learning module 212. In this manner, automated negotiation agent 208 may attempt to use the party's estimated preferences with respect to the issues involved in a negotiation to construct and present offers to the party that the automated negotiation agent 208 perceives the party is likely to accept and that also are advantageous to the party represented by the automated negotiation agent 208.

In order to generate counteroffers to provide to another party in an automated negotiation involving multiple issues, an automated negation agent may attempt to assess the relative importance of the issues involved in the negotiation to the party. In particular, the automated negotiation agent may estimate the relative importance of issues involved in the negotiation for the party based on the party's concession rates for the issues involved in the negotiation. For example, assuming that a party will concede issues it perceives as unimportant more quickly than the party will concede issues it perceives as important, the relative importance of the issues to the party may be estimated based on the party's concession rates for the issues involved in the negotiation. As such, preference weights that are inversely related to the party's corresponding concession rates may be constructed for each of the issues involved in the negotiation in order to model the relative importance of the issues to the party.

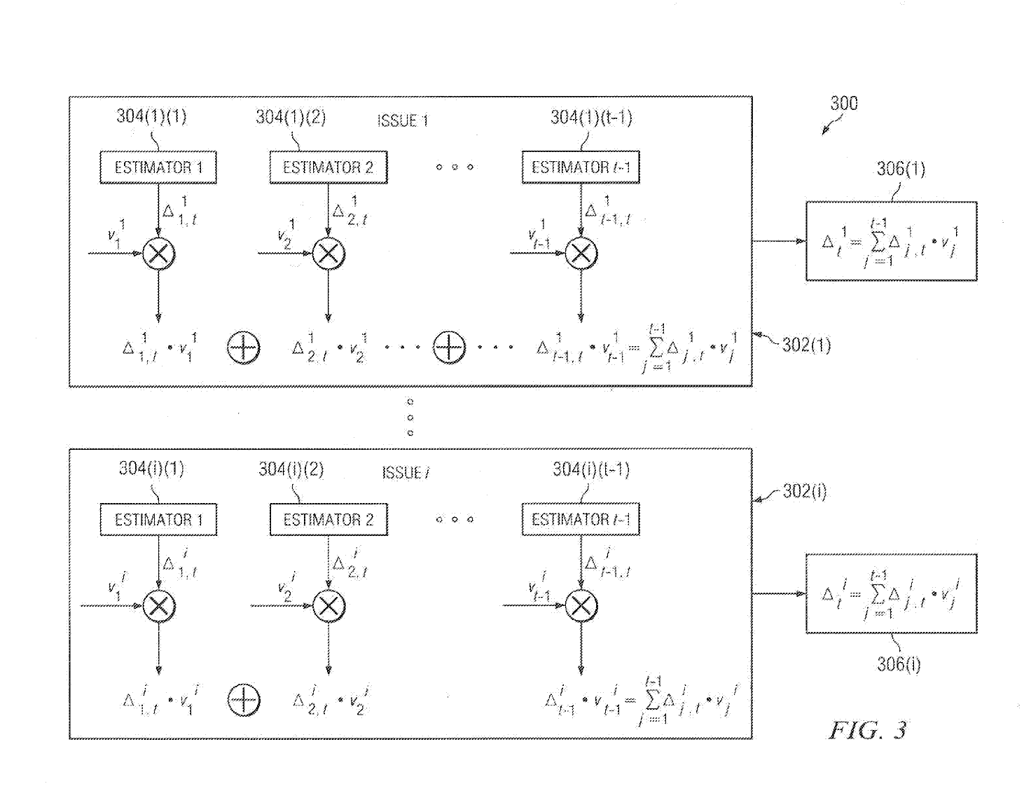

FIG. 3 is a schematic diagram of a system 300 for estimating the relative importance to a party of each of i issues involved in a negotiation. As illustrated in FIG. 3, for each issue i involved in the negotiation, a collection 302 of local estimators 304 is used to generate a global estimate of the party's concession rate for the issue i. At each round t of the negotiation, a new local estimator j 304 is added to the collection 302 of estimators 304 for the issue. For each subsequent round of negotiation, the local estimator j 304 calculates a local estimate of the party's concession rate Δ_{j,t}ⁱ for the issue i, or next incremental change in the terms of the party's offer for issue i, for the issue i based on the values offered by the party for issue i from the round j at which the local estimator j 304 was created through the current round t of the negotiation according to Equation 1:

$${Δ}_{j , t}^{i} = \frac{{\sum }_{k = j + 1}^{t} {X}^{i} ( k ) - {X}^{i} ( k - 1 )}{t - j} \qquad ( Eq . 1 )$$

A global estimate 306 for the party's concession rate for the issue i then is generated by computing a weighted average of the local estimates for the party's concession rate for the issue i:

Δₜⁱ=Σⱼ₌₁^{t-1}Δ_{j,t}ⁱ×vⱼⁱ (Eq. 2)

where v is the weight applied to each local estimate of the concession rate to compute the weighted average.

For the purpose of calculating a global estimate 306 of the concession rate for an issue i at a round t, the weight v_{j,t} to be applied to the local estimate of the concession rate generated by estimator j 304 is determined as a function of the estimator j's performance at the previous round t−1. Specifically, the weight v_{j,t} to be applied at round t to the local estimate of the concession rate generated by estimator j 304 is determined by exponentially decreasing the weight v_{j,t-1} applied to the local estimate of the concession rate generated by estimator j 304 at round t−1 according to the estimation error of estimator j 304 at round t−1:

v_{j,t}ⁱ=e^{-[X}^{ⁱ}^{(t-1)-{X}^{ⁱ}^{(j+1)+Δ}^{_{j,t−1}}^{ⁱ}^{×((t-1)-j+1)}]}^{²} (Eq. 3)

As a result, for the purposes of calculating the global estimate 306 of the concession rate, newer local estimators 304 are weighted more heavily than older local estimators 304 and relatively accurate local estimators 304 are weighted more heavily than relatively inaccurate local estimators 304.

After a global estimate 306 of the party's concession rate for an issue i at round t has been computed, the party's preference weight for the issue (wᵢ) may be calculated according to Equation 4:

wᵢ=e^{-Δ}^{ₜ}^{ⁱ} (Eq. 4)

The automated negotiation agent then may use the preference weights calculated for each of the issues involved in the negotiation to identify counteroffers to provide to the other party to the negotiation. For example, the automated negotiation agent may identify a set of candidate counteroffers that, when applied to a utility function for the party represented by the automated negotiation agent, satisfy a target utility value for the party represented by the automated negotiation agent. Then, the automated negotiation agent may calculate the weighted distances between each of the candidate counteroffers and the other party's offer at round t according to Equation 5:

Dₖ=Σᵢwᵢ(Vₜⁱ−Oₖⁱ (Eq. 5)

where Vₜ represents the other party's offer at round t, and Oₖ represents an individual candidate counteroffer. The automated negotiation agent then may select the candidate counteroffer for which the weighted distance to the other party's offer at round t is closest as a counteroffer to provide to the other party.

Additionally or alternatively, the automated negotiation agent may rank (e.g., from largest to smallest) the preference weights at round t for the issues i involved in the negotiation to determine an estimated order of relative importance of the issues involved in the negotiation to the party (e.g., with issues of higher relative importance having larger preference weights than issues of lower relative importance). The automated negotiation agent then may select the candidate counteroffer from among the set of candidate offers that has the most favorable term to the other party for the issue perceived as being most important to the other party as a counteroffer to present to the other party. That is to say, the automated negotiation agent may select the candidate counteroffer from among the set of candidate counteroffers for which, for the issue perceived as being most important to the other party, the distance between the term of the other party's offer at round t and the candidate counteroffer is the shortest as a counteroffer to present to the other party. For candidate counteroffers where this value is the same, the automated negotiation agent may use the second most highly ranked issue to break ties and so on and so forth until a single counteroffer is identified.

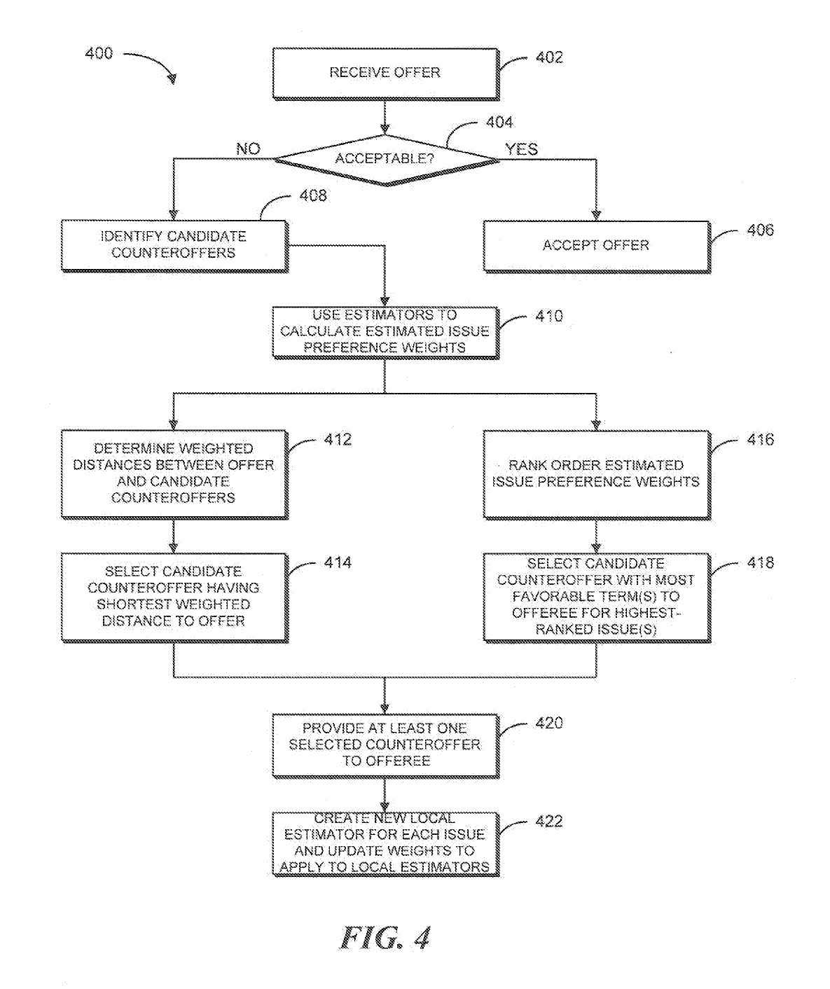

FIG. 4 is a flowchart 400 illustrating an example of a process for conducting an automated negotiation. The process illustrated in the flowchart 400 of FIG. 4 may be performed by an electronic commerce system such as the electronic commerce complex 202 illustrated in FIG. 2. More specifically, the process illustrated in the flowchart 400 of FIG. 4 may be performed by one or more of the processor(s) 210 of the computing device(s) that implement the electronic commerce complex 202 under control of automated negotiation agent 208.

At 402, an offer is received. The terms of this offer then are evaluated at 404 to determine if the offer is acceptable. For example, the terms of the received offer may be applied to a utility function for the party on behalf of whom the automated negotiation is being conducted in order to determine if the offer is acceptable. If application of the terms of the received offer to the utility function results in a utility value equal to or greater than a predetermined target minimum utility value, the offer may be deemed to be acceptable. In contrast, if application of the terms of the received offer to the utility function results in a utility value that is less than the predetermined target minimum utility value, the offer may be deemed unacceptable. If the offer is determined to be acceptable, the offer may be accepted at 406. In contrast, if the offer is determined to be unacceptable, a set of one or more candidate offers having terms that satisfy the target minimum utility value when applied to the utility function may be identified at 408.

In addition, at 410, estimated issue preference weights for the other party to the negotiation may be calculated for each of the issues involved in the negotiation according to Equations 1-4 above. The issue preference weights then may be used to identify one or more counteroffers from among the set of candidate counteroffers to present to the other party to the negotiation. In particular, at 412, the issue preference weights may be used to determine the weighted distance in the issue space between the offer received at 402 and each of the candidate counteroffers. Then, at 414, the candidate counteroffer having the shortest weighted distance to the offer received at 402 may be selected as a first candidate counteroffer to present to the other party to the negotiation.

Additionally or alternatively, at 416, the issue preference weights may be rank ordered to estimate which issue involved in the negotiation is most important to the other party in the negotiation. Then, at 418, the candidate offer having the most favorable terms for the issue perceived as being most important to the other party to the negotiation may be selected as a second counteroffer to present to the other party to the negotiation.

At 420, one or both of the first and second candidate counteroffers selected as counteroffers to be provided to the other party in the negotiation may be provided to the other party in the negotiation. In implementations where only a single one of the first and second selected candidate counteroffers is provided to the other party in the negotiation, different techniques may be employed to choose which of the two selected candidate counteroffers to provide to the other party in the negotiation. For example, in some implementations, the decision of which offer to provide to the other party in the negotiation may be made based on the normalized entropy (E) of the issue preference weights:

$$E = \frac{{\sum }_{i = 1}^{m} {w}_{i} \times {log}_{2} ( {w}_{i} )}{{log}_{2} ( m )} \qquad ( Eq . 6 )$$

where m is the number of issues involved in the negotiation. The higher the value of the normalized entropy for the issue preference weights, the more uniformity there is among the issue preference weights, and, generally speaking, when the issue preference weights are relatively uniform, the counteroffer generated by minimizing the weighted distance to the other party's offer will tend to be received more favorably by the other party to the negotiation than the counteroffer generated by optimizing the issue perceived as being most important to the other party. In contrast, a relatively low value for the normalized entropy for the issue preference weights indicates that the issue preference weights are skewed, and, generally speaking, when the issue preference weights are skewed, the counteroffer generated by optimizing the issue perceived as being most important to the other party in the negotiation will be received more favorably by the other party than the counteroffer generated by minimizing the weighted distance to the other party's offer. Therefore, in implementations where only a single one of the two selected counteroffers are provided to the other party, the first selected counteroffer may be provided to the other party when the normalized entropy for the issue preference weights is equal to or exceeds some predetermined threshold value, while the second selected counteroffer may be provided to the other party when the normalized entropy of the issue preference weights is less than the predetermined threshold value.

At 422, a new local estimator is created for each of the issues involved in the negotiation, and the weights to be applied to the local estimators to calculate the weighted values of the local concession rate estimates are updated. For example, at the conclusion of round t of the negotiation, the weight v_{j,t+1} to be applied to calculate the weighted value of a local concession rate estimate at round t+1 may be updated by exponentially decreasing the weight v_{j,t} applied to the local estimate of the concession rate at round t according to the local concession rate estimate's estimation error at round t:

v_{j,t+1}ⁱ=e^{-[X}^{ⁱ}^{(t)-{X}^{ⁱ}^{(j+1)+Δ}^{_{j,t}}^{ⁱ}^{×(t-j+1)}]}^{²} (Eq. 7)

As described above, in one general aspect, a utility function is accessed for a first party to a potential transaction with a second party that involves multiple issues. In addition, a current offer made by the second party is received that specifies corresponding proposed terms for each of the issues. Estimated weights for the issues involved in the transaction, representing estimates of the relative importance of the issues to the second party, are calculated, and a set of candidate counteroffers specifying proposed terms for each of the issues are identified that, when applied to the utility function, satisfy a target utility value for the first party. Weighted distances between the current offer and the candidate counteroffers based on the estimated weights for the issues involved in the transaction then are calculated, and a counteroffer is selected from among the set of candidate counteroffers based on the weighted distances between the current offer and the candidate counteroffers. The selected counteroffer then is presented to the second party.

Implementations may include one or more of the following features. For example, multiple previous offers made by the second party, each specifying proposed terms for each of the issues, may have been received, and calculating the estimated weights for the issues involved in the transaction may include, for each of the issues involved in the transaction, initializing, upon receipt of each of the previous offers, an estimator corresponding to the previous offer, using each estimator to estimate a local concession rate for the issue by calculating an average change in the terms proposed for the issue by the second party over offers made by the second party between initializing the estimator and receiving the current offer, calculating a global concession rate for the issue based on the calculated local concession rates for the issue, and calculating an estimated weight for the issue based on the calculated global concession rate for the issue.

In some implementations, calculating an estimated weight for the issue based on the calculated global concession rate for the issue may include calculating an estimated weight for the issue that is inversely proportional to the calculated global concession rate for the issue. Furthermore, calculating a global concession rate for an issue based on the calculated local concession rates for the issue may include accessing weights assigned to each of the estimators, and calculating a weighted average of the local concession rates based on the weights assigned to the estimators that calculated the local concession rates. The weights assigned to each of the estimators may represent measures of the ages of the estimators and the accuracies of the estimators to which the weights correspond. The weights assigned to each of the estimators may be updated after calculating the global concession rate for the issue.

In some implementations, selecting a counteroffer from among the set of candidate counteroffers may involve determining which of the candidate counteroffers has the shortest calculated weighted distance to the current offer. In such implementations, the candidate counteroffer determined to have the shortest calculated weighted distance to the current offer then may be selected.

Additionally or alternatively, an estimated rank ordering for the issues involved in the transaction, which represent an estimated rank ordering of the relative importance of the issues to the second party, may be determined (e.g., according to the estimated weights for the issues involved in the transaction). Thereafter, a particular issue may be inferred to be most important to the second party relative to the other issues based on the estimated rank ordering for the issues involved in the transaction. Based on the current offer, a particular counteroffer then may be identified from among the set of candidate counteroffers as specifying a proposed term for the particular issue that is perceived as being favorable to the second party. This particular counteroffer then may be presented to the second party. In such implementations, identifying a particular counteroffer as specifying a proposed term for the particular issue that is perceived as being favorable to the second party may include calculating, for each of the candidate counteroffers, a distance between the term for the particular issue proposed by the second party in the current offer and the term for the particular issue specified in the candidate counteroffer, determining for which of the candidate counteroffers the calculated distance is the shortest, and identifying the candidate counteroffer for which the calculated distance is the shortest as the particular counteroffer.

According to another general aspect, a utility function for a first party to a potential transaction with a second party that involves multiple issues is accessed. In addition, a current offer made by the second party that specifies corresponding proposed terms for each of the issues is received. An estimated rank ordering that represents the relative importance of each of the issues to the second party is determined for the issues involved in the transaction, and, based on the estimated rank ordering for the issues involved in the transaction, a particular issue is inferred to be the most important to the second party relative to the other issues. A set of candidate counteroffers that, when applied to the utility function, satisfy a target utility value for the first party is identified. Thereafter, based on the current offer, a particular counteroffer is identified from among the set of candidate counteroffers as specifying a proposed term for the particular issue that is perceived as being more favorable to the second party than the terms for the particular issue specified by other of the candidate counteroffers. The particular counteroffer then is presented to the second party.

In some implementations, identifying a particular counteroffer as specifying a proposed term for the particular issue that is perceived as being more favorable to the second party than the terms for the particular issue specified by other of the candidate offers may include calculating, for each of the candidate counteroffers, a distance between the term for the particular issue proposed by the second party in the current offer and the term for the particular issue specified in the candidate counteroffer, determining for which of the candidate counteroffers the calculated distance is the shortest, and identifying the candidate counteroffer for which the calculated distance is the shortest as the particular counteroffer.

According to still another general aspect, a utility function for a first party to a potential transaction with a second party that involves multiple issues is accessed. A current offer made by the second party that specifies corresponding proposed terms for each of the issues is received. In addition, based on previously-received offers made by the second party, estimated weights for the issues involved in the transaction that represent estimates of the relative importance of the issues to the second party are calculated. The issues involved in the transaction then are ranked ordered according to the estimated weights, and a particular issue is inferred to be most important to the second party relative to the other issues based on the rank ordering for the issues involved in the transaction. In addition, a set of candidate counteroffers that, when applied to the utility function, satisfy a target utility value for the first party are identified. Weighted distances between the current offer and the candidate counteroffers that are based on the estimated weights for the issues involved in the transaction then are calculated, and a first counteroffer is selected from among the set of candidate counteroffers based on the weighted distances between the current offer and the candidate counteroffers. In addition, based on the current offer, a second counteroffer is identified from among the set of candidate counteroffers as specifying a proposed term for the particular issue that is perceived as being more favorable to the second party than the terms for the particular issue specified by other of the candidate counteroffers. At least one of the first and second counteroffers then is presented to the second party.

Implementations may include one or more of the following features. For example, a measure of similarity between the estimated weights for the issues involved in the transaction may be calculated, a determination may be made that that the measure of similarity between the estimated weights for the issues involved in the transaction exceeds a predetermined threshold value, and, consequently, the first counteroffer may be presented to the second party without the second counteroffer. Alternatively, it may be determined that the measure of similarity between the estimated weights for the issues involved in the transaction is less than a predetermined threshold value, and, consequently, the second counteroffer may be presented to the second party without the first counteroffer.

A number of methods, techniques, systems, and apparatuses have been described. However, additional alternatives are contemplated. For example, while the techniques for automated negotiation described herein generally are described in the context of an automated negotiation agent negotiating on behalf of a seller of a product or service, the techniques can be applied equally well in the context of an automated negotiation agent negotiating on behalf of a buyer of a product or service. Furthermore, while the techniques for automated negotiation described herein generally are described in the context of an automated negotiation agent engaging in a negotiation with a human counterpart, the described techniques also can be applied by an automated negotiation agent engaged in a negotiation with another automated negotiation agent. That is to say, automated negotiation agents as described herein may be opposing-party agnostic. Moreover, the techniques for automated negotiation described herein are not necessarily limited to being applied to negotiations related to the sale/purchase of a product or service. Rather, the techniques for automated negotiation described herein may be applied in many different types of negotiation settings.

The methods, techniques, systems, and apparatuses described herein may be implemented in digital electronic circuitry or computer hardware, for example, by executing instructions stored in computer-readable storage media.

Apparatuses implementing these techniques may include appropriate input and output devices, a computer processor, and/or non-transitory computer-readable storage media storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order, in some implementations, individual operations may be rearranged in a different order, combined with other techniques described herein, and/or eliminated and the desired results still may be achieved. Similarly, components in the disclosed systems may be combined in a different manner and/or replaced or supplemented by other components and the desired results still may be achieved.

What is claimed is:

1. A computer-implemented method comprising:
accessing a utility function for a first party to a potential transaction with a second party that involves multiple issues;
receiving a current offer made by the second party, the current offer specifying corresponding proposed terms for each of the issues;
calculating estimated weights for the issues involved in the transaction, the estimated weights representing estimates of the relative importance of the issues to the second party;
identifying a set of candidate counteroffers that, when applied to the utility function, satisfy a target utility value for the first party, each candidate counteroffer within the set specifying proposed terms for each of the issues;
calculating weighted distances between the current offer and the candidate counteroffers, the weighted distances being based on the estimated weights for the issues involved in the transaction;
selecting a counteroffer from among the set of candidate counteroffers based on the weighted distances between the current offer and the candidate counteroffers; and
causing the selected counteroffer to be presented to the second party.

2. The method of claim 1 further comprising receiving multiple previous offers made by the second party, each previous offer specifying proposed terms for each of the issues, wherein calculating estimated weights for the issues involved in the transaction includes:
for each of the issues involved in the transaction:
upon receipt of each of the previous offers, initializing an estimator corresponding to the previous offer;
using each estimator to estimate a local concession rate for the issue by calculating an average change in the terms proposed for the issue by the second party over offers made by the second party between initializing the estimator and receiving the current offer;
calculating a global concession rate for the issue based on the calculated local concession rates for the issue; and
calculating an estimated weight for the issue based on the calculated global concession rate for the issue.

3. The method of claim 2 wherein calculating, for each of the issues involved in the transaction, an estimated weight for the issue based on the calculated global concession rate for the issue includes calculating, for each of the issues involved in the transaction, an estimated weight for the issue that is inversely proportional to the calculated global concession rate for the issue.

4. The method of claim 2 wherein calculating, for each of the issues involved in the transaction, a global concession rate for the issue based on the calculated local concession rates for the issue includes:
for each of the issues involved in the transaction:
accessing weights assigned to each of the estimators; and
calculating a weighted average of the local concession rates based on the weights assigned to the estimators that calculated the local concession rates.

5. The method of claim 4 wherein accessing, for each of the issues involved in the transaction, weights assigned to each of the estimators includes accessing, for each of the issues involved in the transaction, weights assigned to each of the estimators that represent measures of the ages of the estimators and the accuracies of the estimators to which the weights correspond.

6. The method of claim 4 further comprising updating, for each of the issues involved in the transaction, the weights assigned to each of the estimators after calculating the global concession rate for the issue based on the term for the issue proposed by the second party in the current offer.

7. The method of claim 1 wherein selecting a counteroffer from among the set of candidate counteroffers includes:
determining which of the candidate counteroffers has the shortest calculated weighted distance to the current offer; and
selecting the candidate counteroffer determined to have the shortest calculated weighted distance to the current offer.

8. The method of claim 1 further comprising:
determining an estimated rank ordering for the issues involved in the transaction, the estimated rank ordering representing an estimated rank ordering of the relative importance of the issues to the second party;
based on the estimated rank ordering for the issues involved in the transaction, inferring that a particular issue is most important to the second party relative to the other issues;
identifying, from among the set of candidate counteroffers and based on the current offer, a particular counteroffer as specifying a proposed term for the particular issue that is perceived as being favorable to the second party; and
causing the particular counteroffer to be presented to the second party.

9. The method of claim 8 wherein identifying a particular counteroffer as specifying a proposed term for the particular issue that is perceived as being favorable to the second party includes:
calculating, for each of the candidate counteroffers, a distance between the term for the particular issue proposed by the second party in the current offer and the term for the particular issue specified in the candidate counteroffer;
determining for which of the candidate counteroffers the calculated distance is the shortest; and
identifying the candidate counteroffer for which the calculated distance is the shortest as the particular counteroffer.

10. The method of claim 8 wherein determining an estimated rank ordering for the issues involved in the transaction includes rank ordering the issues involved in the transaction according to the estimated weights for the issues involved in the transaction.

11. A computer-implemented method comprising:
accessing a utility function for a first party to a potential transaction with a second party that involves multiple issues;
receiving a current offer made by the second party, the current offer specifying corresponding proposed terms for each of the issues;
determining an estimated rank ordering for the issues involved in the transaction, the estimated rank ordering representing an estimated rank ordering of the relative importance of the issues to the second party;
based on the estimated rank ordering for the issues involved in the transaction, inferring that a particular issue is most important to the second party relative to the other issues;
identifying a set of candidate counteroffers that, when applied to the utility function, satisfy a target utility value for the first party, each candidate counteroffer within the set specifying proposed terms for each of the issues;
identifying, from among the set of candidate counteroffers and based on the current offer, a particular counteroffer as specifying a proposed term for the particular issue that is perceived as being more favorable to the second party than the terms for the particular issue specified by other of the candidate counteroffers; and
causing the particular counteroffer to be presented to the second party.

12. The method of claim 11 wherein identifying a particular counteroffer as specifying a proposed term for the particular issue that is perceived as being more favorable to the second party than the terms for the particular issue specified by other of the candidate offers includes:
calculating, for each of the candidate counteroffers, a distance between the term for the particular issue proposed by the second party in the current offer and the term for the particular issue specified in the candidate counteroffer;
determining for which of the candidate counteroffers the calculated distance is the shortest; and
identifying the candidate counteroffer for which the calculated distance is the shortest as the particular counteroffer.

13. A non-transitory computer-readable storage medium storing instructions that, when executed by a computer, cause the computer to:
access a utility function for a first party to a potential transaction with a second party that involves multiple issues;
receive a current offer made by the second party, the current offer specifying corresponding proposed terms for each of the issues;
calculate, based on previously-received offers made by the second party, estimated weights for the issues involved in the transaction, the estimated weights representing estimates of the relative importance of the issues to the second party;
rank order the issues involved in the transaction according to the estimated weights;
infer, based on the rank ordering for the issues involved in the transaction, that a particular issue is most important to the second party relative to the other issues;
identify a set of candidate counteroffers that, when applied to the utility function, satisfy a target utility value for the first party, each candidate counteroffer within the set specifying proposed terms for each of the issues;
calculate weighted distances between the current offer and the candidate counteroffers, the weighted distances being based on the estimated weights for the issues involved in the transaction;
select a first counteroffer from among the set of candidate counteroffers based on the weighted distances between the current offer and the candidate counteroffers;
identify, from among the set of candidate counteroffers and based on the current offer, a second counteroffer as specifying a proposed term for the particular issue that is perceived as being more favorable to the second party than the terms for the particular issue specified by other of the candidate counteroffers; and
cause at least one of the first and second counteroffers to be presented to the second party.

14. The computer-readable storage medium of claim 13 wherein the instructions that, when executed by a computer, cause the computer to cause at least one of the first and second counteroffers to be presented to the second party include instructions that, when executed by a computer, cause the computer to:
calculate a measure of similarity between the estimated weights for the issues involved in the transaction;
determine that the measure of similarity between the estimated weights for the issues involved in the transaction exceeds a predetermined threshold value; and
as a consequence of having determined that the measure of similarity between the estimated weights for the issues involved in the transaction exceeds the threshold value, cause the first counteroffer to be presented to the second party without the second counteroffer.

15. The computer-readable storage medium of claim 13 wherein the instructions that, when executed by a computer, cause the computer to cause at least one of the first and second counteroffers to be presented to the second party include instructions that, when executed by a computer, cause the computer to:
calculate a measure of similarity between the estimated weights for the issues involved in the transaction;
determine that the measure of similarity between the estimated weights for the issues involved in the transaction is less than a predetermined threshold value; and
as a consequence of having determined that the measure of similarity between the estimated weights for the issues involved in the transaction is less than the threshold value, cause the second counteroffer to be presented to the second party without the first counteroffer.
